(19) United States
(12) Patent Application Publication
(10) Pub. No.: US 2017/0155980 A1
(43) Pub. Date: Jun. 1, 2017

(54) A METHOD FOR CONTROLLING A SENSING FREQUENCY IN AN ELECTRONIC DEVICE AND THE ELECTRONIC DEVICE THEREOF

(71) Applicant: Samsung Electronics Co., Ltd., Gyeonggi-do (KR)

(72) Inventors: Gyu-Cheol CHOI, Gyeonggi-do (KR); Dong-Il SON, Gyeonggi-do (KR); Chi-Hyun CHO, Gyeonggi-do (KR); Jae-Bong CHUN, Gyeonggi-do (KR); Chang-Ryong HEO, Gyeonggi-do (KR); Chang-Taek KANG, Gyeonggi-do (KR); Changsoo LEE, Gyeonggi-do (KR)

(21) Appl. No.: 15/361,771

(22) Filed: Nov. 28, 2016

(30) Foreign Application Priority Data
Dec. 1, 2015 (KR) 10-2015-0170017

(51) Int. Cl. H04Q 9/00

(52) U.S. Cl. CPC H04Q 9/00; H04L 67/12

(57) ABSTRACT

According to various embodiments of the present disclosure, a communication module operatively coupled to a plurality of sensing devices comprising a 1^{st} sensing device and a 2^{nd} sensing device; and a processor, wherein the processor may perform identifying a 1^{st} information set sensed by using the 1^{st} sensing device and a 2^{nd} information set sensed by using the 2^{nd} sensing device, determining a correlation between the 1^{st} information set and the 2^{nd} information set; grouping the 1^{st} sensing device and the 2^{nd} sensing device based on the correlation; and controlling a sensing period of at least one of the 1^{st} sensing device and the 2^{nd} sensing device.

### CLAIM OF PRIORITY

This application claims the benefit under 35 U.S.C. §119(a) of a Korean patent application filed in the Korean Intellectual Property Office on Dec. 1, 2015, and assigned Serial No. 10-2015-0170017, the entire disclosure of which is hereby incorporated by reference.

### BACKGROUND

1. Field of the Invention

The present disclosure relates to an electronic device and a method of controlling a sensing period of a sensing device by the electronic device, and for example, relates to a method of controlling a sensing period of at least one sensing device among a plurality of sensing devices by the electronic device.

2. Description of the Related Art

An Internet of Things (IoT) environment may be an environment in which data sensed by a sensor built in or included in things or devices is transmitted to a server or another device through the Internet and the things or devices are controlled according to the data. In this environment, sensing devices may be disposed to things or specific places according to respective roles and functions to sense a surrounding environment.

In this case, the sensing devices operate by using a battery in general, and capacity of the battery may be limited since a size of the sensing devices and a place to attach the devices are restricted.

In order to increase a battery duration time of the sensing device, there may be a method of improving components included in the sensing device, which may cause a cost increase in the sensing device. Further, once the sensing device is manufactured, it may be difficult to improve the sensing device.

In case of using an ultra low-power communication scheme to increase the battery duration time of the sensing device, for example, in case of using a Bluetooth Low Energy (BLE) communication scheme, the overhead of data transmitted/received by the sensing device may be great. Further, in case of using a communication scheme such as z-wave or zigbee, there may be a standardization problem, a frequency band interference caused by the use of the Industrial Scientific Medical (ISM) band, or various other problems caused by the use of a high frequency.

Accordingly, there may be a need for a method in which the battery duration time of the sensing device is increased and a sensing value collected by the sensing device is effectively acquired by the electronic device. Further, there may be a need for a method of minimizing capacity of a memory in which the sensing value is stored.

### SUMMARY

According to various embodiments of the present disclosure, in the electronic device operatively coupled to a plurality of sensing devices comprising a 1^{st} sensing device and a 2^{nd} sensing device, identifying a 1^{st} information set by using the 1^{st} sensing device; identifying a 2^{nd} information set sensed by using the 2^{nd} sensing device; determining a correlation between the 1^{st} information set and the 2^{nd} information set; grouping the 1^{st} sensing device and the 2^{nd} sensing device based on the correlation; and controlling a sensing period of at least one of the 1^{st} sensing device and the 2^{nd} sensing device.

According to various embodiments of the present disclosure, an electronic device comprising a communication module operatively coupled to a plurality of sensing devices comprising a 1^{st} sensing device and a 2^{nd} sensing device; and a processor, wherein the processor is configured for identifying a 1^{st} information set sensed by using the 1^{st} sensing device and a 2^{nd} information set sensed by using the 2^{nd} sensing device, determining a correlation between the 1^{st} information set and the 2^{nd} information set; grouping the 1^{st} sensing device and the 2^{nd} sensing device based on the correlation; and controlling a sensing period of at least one of the 1^{st} sensing device and the 2^{nd} sensing device.

### BRIEF DESCRIPTION OF THE DRAWINGS

FIG. 1A and FIG. 1B illustrate a system for controlling a sensing device according to various embodiments;

FIG. 2 is a block diagram of an electronic device in a network environment according to various embodiments;

FIG. 3 is a block diagram of an electronic device according to various embodiments;

FIG. 4 is a block diagram of a program module according to various embodiments;

FIG. 5 is a flowchart illustrating an operation of controlling a sensing period of a sensing device by an electronic device according to various embodiments;

FIG. 6 is a flowchart illustrating a detailed operation of identifying a relation between a 1^{st} information set and a 2^{nd} information set by an electronic device according to various embodiments;

FIG. 7 illustrates a menu for selecting a sensing attribute according to various embodiments;

FIG. 8A and FIG. 8B are graphs illustrating sensing values measured in sensing devices according to various embodiments;

FIG. 9A, FIG. 9B, and FIG. 9C are tables illustrating a sensing period of each of sensing devices before/after an electronic device determines the sensing period according to various embodiments;

FIG. 10 is a flowchart illustrating a process of controlling a sensing period of a sensing device by an electronic device according to various embodiments; and

FIG. 11 is a flowchart illustrating a process of controlling a sensing period of a sensing device by an electronic device according to various embodiments.

### DETAILED DESCRIPTION

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications, equivalents, and/or alternatives within the spirit and scope of the present disclosure. In the description of the drawings, similar reference numerals may be used to designate similar elements.

As used in various embodiments of the present disclosure, the expressions “include”, “may include” and other conjugates refer to the existence of a corresponding disclosed function, operation, or constituent element, and do not limit one or more additional functions, operations, or constituent elements. Further, as used in various embodiments of the present disclosure, the terms “include”, “have”, and their conjugates are intended merely to denote a certain feature, numeral, step, operation, element, component, or a combination thereof, and should not be construed to initially exclude the existence of or a possibility of addition of one or more other features, numerals, steps, operations, elements, components, or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

In the present disclosure, expressions including ordinal numbers, such as “first” and “second,” and the like, may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element may be termed a second element, and likewise a second element may also be termed a first element without departing from the scope of various embodiments of the present disclosure.

When an element is referred to as being “coupled” or “connected” to any other element, it should be understood that not only the element may be coupled or connected directly to the other element, but also a third element may be interposed therebetween. Contrarily, when an element is referred to as being “directly coupled” or “directly connected” to any other element, it should be understood that no element is interposed therebetween. Additionally, “communicatively connected” shall include connected in a manner so that the communicatively connected devices can communication electronically, including having established a wireless point-to-point radio communication link.

The terms as used in various embodiments of the present disclosure are used merely to describe a certain embodiment and are not intended to limit the present disclosure. As used herein, singular forms may include plural forms as well unless the context explicitly indicates otherwise. Furthermore, all terms used herein, including technical and scientific terms, have the same meaning as commonly understood by those of skill in the art to which the present disclosure pertains. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to various embodiments of the present disclosure may be a device including a communication function. For example, the electronic device may include at least one of a Smartphone, a Tablet Personal Computer (PC), a Mobile Phone, a Video Phone, an Electronic Book (e-book) reader, a Desktop PC, a Laptop PC, a Netbook Computer, a Personal Digital Assistant (PDA), a Portable Multimedia Player (PMP), an MP3 player, a Mobile Medical Appliance, a Camera, and a Wearable Device (e.g. a Head-Mounted-Device (HMD) such as electronic glasses, electronic clothes, an electronic bracelet, an electronic necklace, an electronic appcessory, electronic tattoos, or a smartwatch).

According to some embodiments, the electronic device may be a smart home appliance with a communication function. For example, the smart home appliance may include at least one of a television, a digital video disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter).

According to various exemplary embodiments, an electronic device may be one of Internet of Things (IoT) devices. The IoT devices may include a device of Internet of things. For example, the IoT devices may be a part of a Closed Circuit Television (CCTV) camera, a home robot, an Internet-connectable home appliance such as a refrigerator, a water purifier, a TV, etc., a medical device, furniture, and a building/construction.

According to various exemplary embodiments, the electronic device may be a device (e.g., a computer, a home robot, etc.) located in an indoor area, processing a sensing value received from the sensing device, and supporting an interaction function with respect to a user.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter).

The electronic device according to various embodiments of the present disclosure may be a combination of one or more of the aforementioned various devices. Further, the electronic device according to various embodiments of the present disclosure may be a flexible device. Further, it will be apparent to those skilled in the art that the electronic device according to various embodiments of the present disclosure is not limited to the aforementioned devices.

Hereinafter, an electronic device according to various embodiments of the present disclosure will be described with reference to the accompanying drawings. The term “user” as used in various embodiments of the present disclosure may indicate a person who uses an electronic device or a device (e.g., artificial intelligence electronic device) that uses an electronic device.

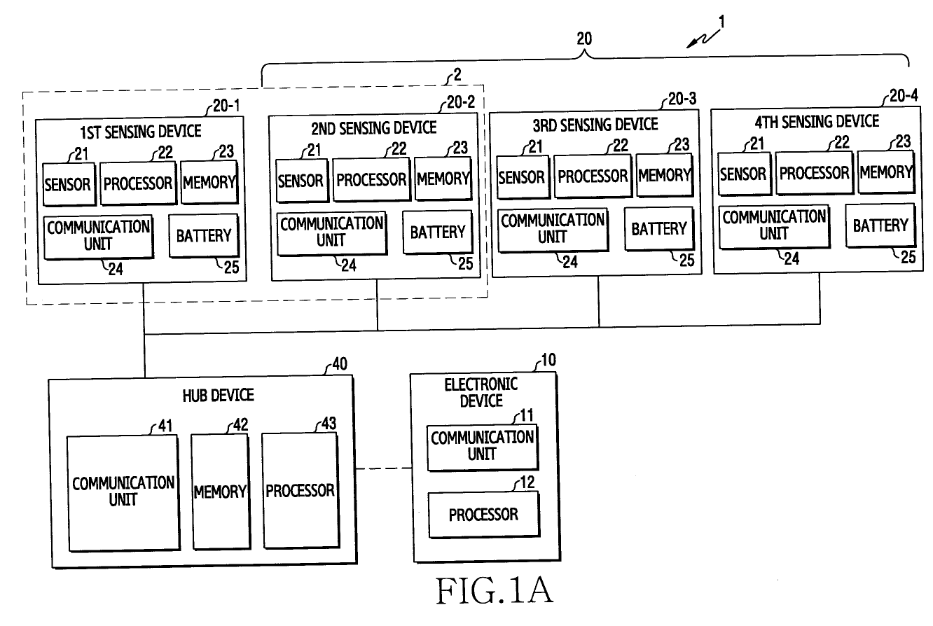

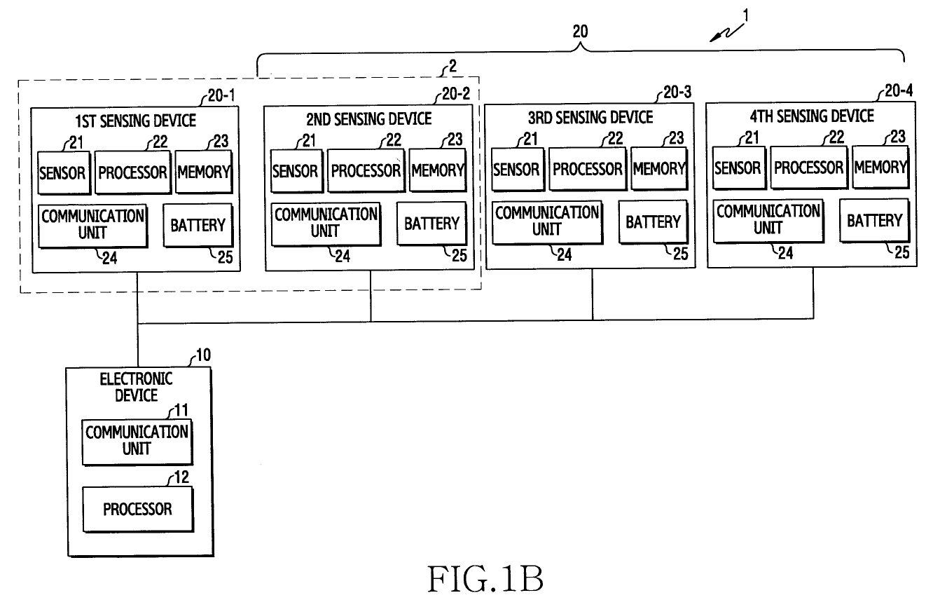

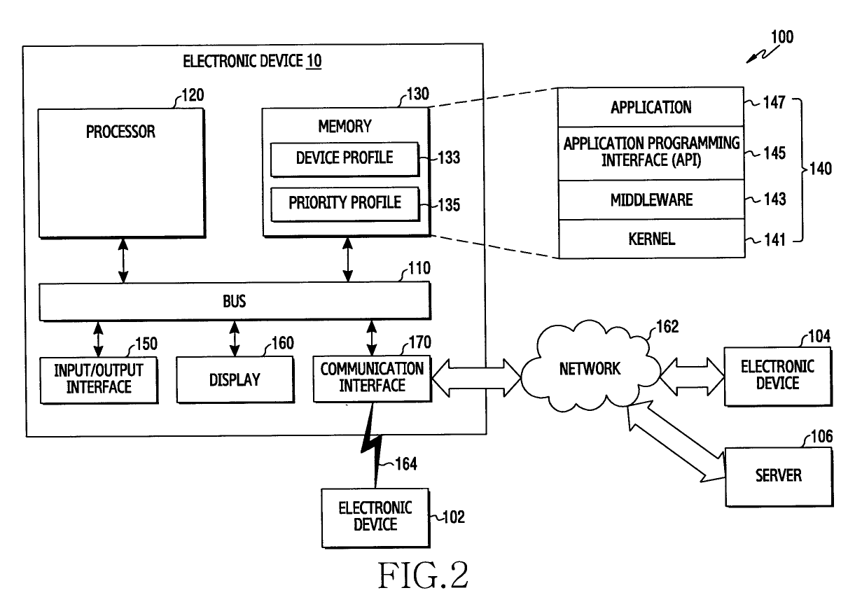

FIG. 1A and FIG. 1B illustrate a system for controlling a sensing device according to various exemplary embodiments of the present disclosure.

In FIG. 1A, a system 1 may include sensing devices 20, a hub device 40, and an electronic device 10. In the present disclosure, the sensing device 20 may imply any one of sensing devices 20-1, 20-2, 20-3, and 20-4 connected to the hub device 40.

In FIG. 1A, the sensing devices 20 may be a device for sensing surrounding environment information.

Although the sensing devices 20 may include a sensor 21, a processor 22, a memory 23, a communication unit 24, and a battery 25, it may be understood that some of the aforementioned elements may be omitted or other elements may be included.

The sensor 21 of the sensing devices 20 may be, for example, a thermometer, a hygrometer, a camera, a proximity detector, a door alarm, barometer, or a gas sensor. Alternatively, the sensor 21 may be a sensor configured by combining two or more of the aforementioned sensors.

The communication unit 24 of the sensing devices 20 may be connected to the hub device 40 according to a short-range wireless communication scheme. For example, the communication unit 24 may support the short-range wireless communication scheme such as WiFi, zigbee, bluetooth, or z-wave. Further, each of the sensing devices may also support a different short-range wireless communication scheme. For example, the 1^{st} sensing device 20-1 may support WiFi, and the 2^{nd} sensing device 20-2 may support Bluetooth.

The communication unit 24 can include, but is not limited to, an antenna, receivers, transmitters, modems, and filters, or any combination thereof.

The processor 22 of the sensing devices 20 may control an overall operation of the sensing devices 20. For example, the processor 22 may store a sensing value obtained by sensing surrounding environment information by the sensor 21 into the memory 23, or may transmit the sensing value to another device via the communication unit 24. In this case, the sensing devices 20 may sense the surrounding environment information in every specific period. Alternatively, the sensing devices 20 may sense the surrounding environment information upon sensing an external event. For example, the external event may be a signal received from an external device (e.g., the hub device 40 or the electronic device 10) to request the sensing of the sensing devices 20.

For example, the processor 22 may identify a remaining amount of power of the battery 25, and may transmit the remaining amount of power of the battery 25 to the hub device 40 or the electronic device 10 via the communication unit 24. For another example, the processor 22 may transmit battery information together with the sensing value.

In the present disclosure, the sensing devices 20 may be sensing devices for sensing different environment information, or may be sensing devices for sensing the same environment information. In case of the sensing devices for sensing the same environment information, each of the sensing devices 20 may be provided in a different position.

In FIG. 1A, the hub device 40 may be a device for transmitting to the electronic device 10 the sensing values received from the sensing devices 20.

For example, the hub device 40 may be a device for transmitting to the electronic device located in an outdoor area the sensing values received from the sensing devices 20 located in an indoor area. Alternatively, the hub device 40 may be a device for playing a bridge role which connects the sensing devices 20 for performing communication using a short-range communication scheme and the electronic device 10 for performing communication using a far-range communication scheme.

In general, the hub device 40 may be a gateway. The hub device 40 may also be a device (e.g., a home robot, etc.) which processes data received from the sensing devices 20 or which supports an interaction function with respect to a user.

Although the hub device 40 may include a communication unit 41 (the communication unit 41 can include, but is not limited to, an antenna, receivers, transmitters, modems, and filters, or any combination thereof), a memory 42, and a processor 43, it may be understood by those ordinarily skilled in the art that some elements among the aforementioned constitutional elements may be omitted or other general-purpose constitutional elements may be included.

The communication unit 41 may communicate with the sensing devices 20 and the electronic device 10. For example, a 1^{st} communication unit (not shown) for performing near-range wireless communication with the sensing devices 20 and a 2^{nd} communication unit (not shown) for performing far-range wireless communication with the electronic device 10 may be included. The 1^{st} communication unit may support a near-range wireless communication scheme such as WiFi, zigbee, bluetooth, or z-wave. Further, the 2^{nd} communication unit may support a far-range wireless communication scheme such as Long-Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), or Global System for Mobile Communications (GSM). Furthermore, the 2^{nd} communication unit may communicate with the electronic device 10 via a computer network (e.g., LAN or WAN), the Internet, or a telephone network.

The processor 43 of the hub device 40 may control the overall operation of the hub device 40. For example, the processor 43 may cause the communication unit 41 to receive measurements (sensing values) from the sensing devices 20. Further, the processor 43 may write the sensing values into the memory 42. Furthermore, the processor 43 may cause the communication unit 41 to deliver the sensing values to the electronic device 10. For example, the processor 43 may cause the communication unit 41 to receive battery information (such as remaining battery power). Further, the processor 43 may write the received battery information into the memory 42. Furthermore, the processor 43 may cause the communication unit 41 to deliver the battery information to the electronic device 10.

In FIG. 1A, the electronic device 10 may receive from the hub device 40 the sensing values sensed by the sensing devices 20, and may manage and analyze the values.

For example, the electronic device 10 may detect that the indoor area is illuminated on the basis of the received sensing value (for example, a luminosity reading from the camera). In response, the electronic device 10 may transmit a command controlling the illumination in the indoor area where the hub device 40 is located. Alternatively, the electronic device 10 may identify a temperature setting pattern of the user on the basis of the received sensing value (for example, a thermometer), and according thereto, may transmit a command for setting an indoor temperature (such as setting a thermostat, causing a heater to operate, or setting an air conditioner) preferred by the user to the hub device 40.

The electronic device 10 may be operatively coupled to the plurality of sensing devices 20. Being operatively coupled may include, for example, that the electronic device 10 can be directly or indirectly connected for communication with the plurality of sensing devices 20. When it is said that the electronic device 10 is indirectly connected for communication with the plurality of sensing devices 20, this includes, for example, that the electronic device 10 is connected to the plurality of sensing devices 20 via a relay as shown in FIG. 1A. In the present disclosure, the relay may be, for example, the hub device 40. Further, when it is said that the electronic device 10 is directly connected for communication with the plurality of sensing devices 20, this may include, for example, a meaning that the electronic device 10 is connected for communication with the plurality of sensing devices 20 without the relay as shown in FIG. 1B to be described below.

In FIG. 1A, although the electronic device 10 may include a communication unit 11 and a processor 12, it may be understood by those ordinarily skilled in the art that some constitutional elements among the aforementioned constitutional elements may be omitted or other general-purpose constitutional elements may be included.

The communication unit 11 (the communication unit 11 can include, but is not limited to, an antenna, receivers, transmitters, modems, and filters, or any combination thereof) may communicate with the hub device 40. For example, the communication unit 11 may be communicatively connected with the hub device 40 according to a far-range wireless communication scheme. For example, the communication unit 11 may support a far-range wireless communication scheme such as LTE, LTE-A, CDMA, WCDMA, UMTS, WiBro, or GSM. Further, the communication unit 11 may communicate with the hub device 40 via a computer network (e.g., LAN or WAN), the Internet, or a telephone network. For example, the communication unit 11 may receive the sensing values from the sensing devices 20. For example, the communication unit 11 may receive battery information from the sensing devices 20.

The processor 12 of the electronic device 10 may control the overall operation of the electronic device 10.

In one exemplary embodiment, the processor 12 may identify information sets as a group of sensing values sensed by using the sensing devices 20. For example, the processor 12 may identify a 1^{st} information set as a group of sensing values sensed by using the 1^{st} sensing device 20-1, and may identify a 2^{nd} information set as a group of sensing values sensed by using the 2^{nd} sensing device 20-2. In this case, identifying of the information set may include, for example, calculating the information set, extracting the information set, searching for the information set, distinguishing the information set, acquiring the information set from an external device or from a memory, or deriving the information set as a result thereof.

Next, the processor 12 may identify a relation between the 1^{st} information set and the 2^{nd} information set on the basis of comparison between the 1^{st} information set and the 2^{nd} information set associated with the 1^{st} information set. In this case, the 2^{nd} information set associated with the 1^{st} information set may be, for example, an information set having the same or similar sensing attribute as the 1^{st} information set. For example, the 2^{nd} information set associated with the 1^{st} information set may be an information set having the same or similar sensing type as the 1^{st} information set, or an information set having the same or similar sensing time period as the 1^{st} information set.

Next, the processor 12 may create a second group by selecting the 1^{st} sensing device 20-1 and the 2^{nd} sensing device 20-2 among the plurality of sensing devices 20 on the basis of the relation. The electronic device 10 may control a sensing time period of at least one sensing device 20 included in the second group. For example, the electronic device 20 may control the sensing period such that the sensing devices 20 included in the second group have the same sensing period. Alternatively, the electronic device 10 may control the sensing period such that the sensing devices 20 included in the second group have different sensing periods.

According to one exemplary embodiment, in case of controlling the sensing period of at least one sensing device 20 included in the second group, the processor 12 may determine the sensing period of the at least one sensing device 20 included in the second group such that the sensing devices included in the second group have different sensing times at which a surrounding environment is sensed.

According to one exemplary embodiment, in case of identifying the relation between the 1^{st} information set and the 2^{nd} information set, the processor 12 may identify a difference between a sensing time for at least a part of the 1^{st} information set and a sensing time for at least a part of the 2^{nd} information set, and if the difference of the sensing times satisfies a designated range, for example, less than a particular threshold, may associate at least the part of the 1^{st} information set and at least the part of the 2^{nd} information set.

According to one exemplary embodiment, in case of identifying the relation between the 1^{st} information set and the 2^{nd} information set, the processor 12 may compare a 1^{st} change pattern of the 1^{st} information and a 2^{nd} change pattern of the 2^{nd} information set associated with the 1^{st} information set.

According to one exemplary embodiment, in case of selecting and grouping the 1^{st} sensing device 20-1 and the 2^{nd} sensing device 20-2, the processor 12 may group the 1^{st} sensing device and the 2^{nd} sensing device if a difference between the 1^{st} change pattern and the 2^{nd} change pattern is less than or equal to a threshold.

According to one exemplary embodiment, in case of controlling a sensing period of at least one sensing device 20 included in the second group, the processor 12 may determine or set the sensing period of the at least one sensing device 20 such that the at least one sensing device does not transmit to-be-sensed information (e.g., a sensing value) at a designated time to the electronic device 10.

According to one exemplary embodiment, in case of controlling the sensing period of the at least one sensing device 20 included in the second group, the processor 12 may transmit a command for requesting the at least one sensing device included in the second group to sense the surrounding environment according to the determined sensing period to the at least one sensing device 20 via the communication unit 11.

According to one exemplary embodiment, the command for requesting the at least one sensing device included in the second group to sense the surrounding environment according to the determined sensing period may include the sensing period of the at least one sensing device 20 and an operation condition of the sensing period.

According to one exemplary embodiment, in case of controlling the sensing period of the at least one sensing device 20 included in the second group, the processor 12 may transmit a command for requesting the at least one sensing device 20 to perform sensing with the 1^{st} sensing period via the communication unit 11. When the designated time elapses, a command for requesting the at least one sensing device to perform sensing with a 2^{nd} sensing period different from the 1^{st} sensing period may be transmitted to the at least one sensing device 20 via the communication unit 11.

According to one exemplary embodiment, in case of determining at least one of a sensing attribute and a sensing time slot and identifying the 1^{st} information set and the 2^{nd} information set, the processor 12 may identify an information set including a sensing value corresponding to at least one of the determined sensing attribute and sensing time slot.

Meanwhile, as shown in the system 1 of FIG. 1B, the electronic device 10 may perform communication directly with the sensing devices 20. In this case, the electronic device 10 may be configured to perform a function of the aforementioned hub device 40. For example, the processor 12 of the electronic device 10 may play a role of the processor 43 of the hub device 40 in a substitutive manner. Further, the communication unit 11 of the electronic device 10 may play a role of the communication unit 41 of the hub device 40 in a substitutive manner.

When the electronic device 10 performs communication directly with the sensing devices 20, the communication unit 11 of the electronic device 10 may receive sensing values from the sensing devices 20. Alternatively, the communication unit 11 may receive battery information from the sensing devices 20. The processor 12 of the electronic device 10 may identify a 1^{st} information set as a group of sensing values received by the communication unit 11, and may identify a 2^{nd} information set as a group of sensing values received by using the 2^{nd} sensing device 20-2.

The processor 12 may identify a relation between the 1^{st} information set and the 2^{nd} information set on the basis of comparison between the 1^{st} information set and the 2^{nd} information set associated. The processor 12 may select and group the 1^{st} sensing device 20-1 and the 2^{nd} sensing device 20-2 among the plurality of sensing devices 20 on the basis of the identified relation. The processor 12 may control the sensing period of at least one sensing device 20 among the sensing devices 20 included in the group. The processor 12 may control the sensing period of the at least one sensing device 20 among the sensing devices 20 included in the group on the basis of the battery information of the sensing devices 20 included in the group. For example, if a ratio of a battery remaining amount of the 1^{st} sensing device 20-1 included in the second group to a battery remaining amount of the 2^{nd} sensing device 20-2 is 2:1, the processor 12 may determine a sensing occurrence rate between the 1^{st} sensing device 20-1 and the 2^{nd} sensing device 20-2 as 2:1, and may control sensing periods of the 1^{st} sensing device 20-1 and the 2^{nd} sensing device 20-2 on the basis of the determined sensing occurrence rate.

For example, the electronic device 10 may determine that there is a relationship between the air pressure and humidity. However, if the remaining battery power associated with the barometer is low compared to the battery power associated with the hygrometer, the electronic device 10 may increase the frequency of the hygrometer measurements and decrease the frequency of the barometer readings.

FIG. 2 is a diagram illustrating a network environment 100 including an electronic device according to various embodiments of the present disclosure. Referring to FIG. 2, the electronic device 10 may include a bus 110, a processor 120, a memory 130, an input/output (I/O) interface 150, a display 160, and a communication interface 170. In a certain exemplary embodiment, the electronic device 10 may omit at least one of the elements, or may additionally have other elements.

In this case, the processor 120 of the electronic device 10 of FIG. 2 may correspond to the processor 12 of the electronic device 10 of FIG. 1A and FIG. 1B, and the communication interface 170 of the electronic device 10 of FIG. 2 may correspond to the communication unit 11 of FIG. 1A and FIG. 1B.

The processor 120 may identify information sets as a group of sensing values sensed by sensing devices, identify a relationship between information sets by comparing the information sets, create a group of the sensors associated with the related information sets, and control the frequency that the sensors take measurements based on the remaining battery power associated therewith.

The bus 110 may, for example, be a circuit for connecting the above-described elements with each other, and transferring communication (e.g., a control message) between the above-described elements 110-170.

According to an embodiment of the present disclosure, the processor 120 may include one or more application processors (APs), one or more central processing units (CPUs), and one or more communication processors (CPs). The processor 120 may receive, for example, an instruction from the above-described other elements (e.g., the memory 130, the I/O interface 140, the display 150, or the communication interface 160, etc.) via the bus 110, decipher the received instruction, and execute an operation or a data process corresponding to the deciphered instruction.

The memory 130 may include device profile 133 or apriority profile 134. The memory 130 may store commands or data (e.g., a reference pattern or a reference touch area) associated with one or more other components of the electronic device 10. According to an embodiment of the present disclosure, the memory 130 may store software and/or a program. For example, the program may include a kernel 141, a middleware 143, an application programming interface (API) 145, an application program 147, or the like. At least some of the kernel 141, the middleware 143, and the API 145 may be referred to as an OS.

The kernel 141 may control or manage system resources (e.g., the bus 110, the processor 120, or the memory 130) used for performing an operation or function implemented by the other programs (e.g., the middleware 143, the API 145, or the applications 147). Furthermore, the kernel 141 may provide an interface through which the middleware 143, the API 145, or the applications 147 may access the individual elements of the electronic device 101 to control or manage the system resources.

The middleware 143, for example, may function as an intermediary for allowing the API 145 or the applications 147 to communicate with the kernel 141 to exchange data.

In addition, the middleware 143 may process one or more task requests received from the applications 147 according to priorities thereof. For example, the middleware 143 may assign priorities for using the system resources (e.g., the bus 110, the processor 120, the memory 130, or the like) of the electronic device 101, to at least one of the applications 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, or text control.

In certain embodiments, the memory 130 may store grouped information sets written to the memory by the processor 120.

The I/O interface 150 may forward an instruction or data inputted from a user through an I/O device (e.g., various sensors such as an acceleration sensor and a gyro sensor and/or a device such as a keyboard or a touch screen), for example, to the processor 120, the memory 130 or the communication interface 170 through the bus 110. For example, the I/O interface 150 may provide data about a user's touch inputted through a touch screen, to the processor 120. Also, the I/O interface 150 may, for example, output an instruction or data received from the processor 120, the memory 130 and the communication interface 170 through the bus 110, through an output device (e.g., a speaker or the display 160). For example, the I/O interface 150 may output voice data processed by the processor 120, to a user through the speaker.

The display 160 may include, for example, a liquid crystal display (LCD), a light emitting diode (LED) display, an organic LED (OLED) display, a micro electro mechanical system (MEMS) display, an electronic paper display, and the like. The display 160, for example, may display various types of content (e.g., a text, images, videos, icons, symbols, and the like) for the user. The display 160 may include a touch screen and receive, for example, a touch, a gesture, proximity, a hovering input, and the like, using an electronic pen or the user's body part. According to an embodiment of the present disclosure, the display 160 may display a web page.

The communication interface 170, for example, may set communication between the electronic device 101 and an external device (e.g., the first external electronic device 102, the second external electronic device 104, or the server 106). For example, the communication interface 170 may be connected to a network 162 through wireless or wired communication to communicate with the external device (e.g., the second external electronic device 104 or the server 106).

Additionally, the communication interface 170 can receive information sets from sensors 20-1-20-4.

The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth, Bluetooth low energy (BLE), near field communication (NFC), or Zigbee. The wireless communication may also utilize a global navigation satellite system (GNSS).

The GNSS may include at least one of, for example, a GPS, a global navigation satellite system (Glonass), a Beidou navigation satellite system (hereinafter, referred to as “Beidou”), and European global satellite-based navigation system (Galileo). Hereinafter, in an embodiment of the present disclosure, the “GPS” may be interchangeably used with the “GNSS”. The wired communication may include, for example, at least one of a universal serial bus (USB), a high definition multimedia interface (HDMI), recommended standard 232 (RS-232), and a plain old telephone service (POTS). The network 162 may include at least one of a communication network, such as a computer network (e.g., a local area network (LAN) or a wide area network (WAN)), the internet, and a telephone network.

Each of the first external electronic device 102 and the second external electronic device 104 may be a device which is the same as or different from the electronic device 10. According to an embodiment of the present disclosure, the server 106 may include a group of one or more servers. According to various embodiments of the present disclosure, all or a part of operations performed in the electronic device can be performed in the other electronic device or multiple electronic devices (e.g., the first external electronic device 102 or the second external electronic device 104 or the server 106). According to an embodiment of the present disclosure, when the electronic device 10 should perform some functions or services automatically or by a request, the electronic device 10 may make a request for performing at least some functions related to the functions or services to another device (e.g., the first external electronic device 102 or the second external electronic device 104, or the server 106) instead of performing the functions or services by itself or additionally. Another electronic device (e.g., the first external electronic device 102 or the second external electronic device 104, or the server 106) may perform a function requested from the electronic device 10 or an additional function and transfer the performed result to the electronic device 10. The electronic device 10 can provide the requested function or service to another electronic device by processing the received result as it is or additionally. To this end, for example, cloud computing, distributed computing, or client-server computing technology may be used.

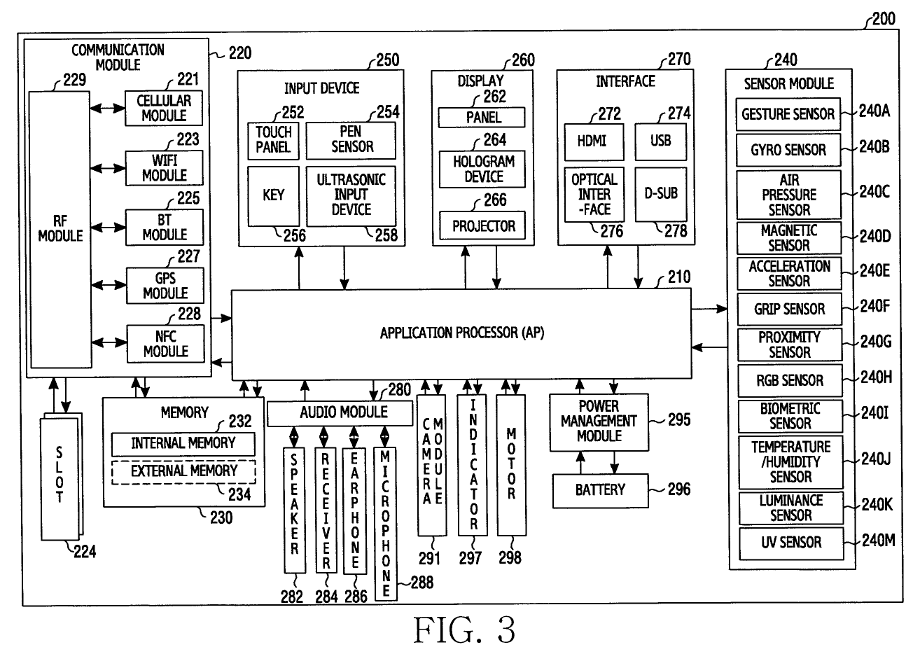

FIG. 3 is a block diagram of an electronic device 10 according to various exemplary embodiments. The electronic device 10 may include all or some parts of the electronic device 10 of FIG. 2. The electronic device 10 may include one or more processors (e.g., an Application Processor (AP)) 210, a communication module 220, a Subscriber Identification Module (SIM) module 224, a memory 230, a sensor module 240, an input unit 250, a display 260, an interface 270, an audio module 280, a camera module 291, a power management module 295, a battery 296, an indicator 297, and a motor 298.

In this case, the processor 210 of the electronic device 10 of FIG. 3 may correspond to the processor 12 of the electronic device 10 of FIG. 1A and FIG. 1B, and the communication module 220 of the electronic device 10 of FIG. 3 may correspond to the communication unit 11 of FIG. 1A and FIG. 1B.

The processor 210 may control a plurality of hardware or software components connected to the processor 210 by driving an OS or an application program and perform processing of various pieces of data and calculations. The processor 210 may be implemented by, for example, a system on chip (SoC). According to an embodiment of the present disclosure, the processor 210 may further include a graphics processing unit (GPU) and/or an image signal processor (ISP). The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The processor 120 may identify information sets as a group of sensing values sensed by sensing devices, identify a relationship between information sets by comparing the information sets, create a group of the sensors associated with the related information sets, and control the frequency that the sensors take measurements based on the remaining battery power associated therewith.

The communication module 220 may have a configuration equal or similar to that of the communication interface 170 of FIG. 1. The communication module 220 may include, for example, the cellular module 221, a Wi-Fi module 222, a Bluetooth module 223, a GNSS module 224 (e.g., a GPS module, a Glonass module, a Beidou module, or a Galileo module), an NFC module 225, an MST module 226, and a radio frequency (RF) module 227. Additionally, the communication module 220 can receive information sets from sensors 20-1-20-4.

The cellular module 221 may provide a voice call, image call, a text message service, or an Internet service through, for example, a communication network. According to an embodiment of the present disclosure, the cellular module 221 may distinguish between and authenticate electronic devices 10 within a communication network using a subscriber identification module (e.g., the SIM card 229). According to an embodiment of the present disclosure, the cellular module 221 may perform at least some of the functions that the processor 210 may provide. According to an embodiment of the present disclosure, the cellular module 221 may include a CP.

Each of the Wi-Fi module 222, the BT module 223, the GNSS module 224, the NFC module 225 and the MST module 226 may include, for example, a processor for processing data transmitted and received through the relevant module. According to various embodiments of the present disclosure, at least some (e.g., two or more) of the cellular module 221, the Wi-Fi module 222, the BT module 223, the GNSS module 224, the NFC module 225, and the MST module 226 may be included in one integrated chip (IC) or IC package.

The RF module 227 may transmit/receive, for example, a communication signal (e.g., an RF signal). The RF module 227 may include, for example, a transceiver, a power amp module (PAM), a frequency filter, a low noise amplifier (LNA), and/or an antenna. According to another embodiment of the present disclosure, at least one of the cellular module 221, the Wi-Fi module 222, the Bluetooth module 223, the GNSS module 224, the NFC module 225, or the MST module 226 may transmit and receive RF signals through a separate RF module(s).

The subscriber identification module 229 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) may include, for example, an internal memory 232 or an external memory 234. The internal memory 232 may include at least one of, for example, a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a flash memory (e.g., a NAND flash memory or a NOR flash memory), a hard driver, or a solid state drive (SSD). In certain embodiments, the memory 130 may store grouped information sets written to the memory by the processor 120.

An external memory 234 may further include a flash drive, for example, a compact flash (CF), a secure digital (SD), a Micro-SD, a Mini-SD, an extreme digital (xD), a multi-media card (MMC), a memory stick, and the like. The external memory 234 may be functionally and/or physically connected to the electronic device 10 through various interfaces.

The sensor module 240 may measure a physical quantity or detect an operation state of the electronic device 10, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In various embodiments of the present disclosure, an electronic device 10 may further include a processor configured to control the sensor module 240 as a part of or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive scheme, a resistive scheme, an infrared scheme, and an ultrasonic scheme. In addition, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key, a keypad, and the like. The ultrasonic input device 258 may detect ultrasonic wave generated by an input tool through a microphone (e.g., a microphone 288) and identify data corresponding to the detected ultrasonic waves.

The display 260 (e.g., the display 160) may include a panel 262, a hologram device 264, or a projector 266. The panel 262 may include a configuration identical or similar to that of the display 160 illustrated in FIG. 2. The panel 262 may be implemented to be, for example, flexible, transparent, or wearable. The panel 262 and the touch panel 252 may be configured by one module. The hologram device 264 may show a three dimensional image in the air by using an interference of light. The projector 266 may display an image by projecting light onto a screen. The screen may be located, for example, inside or outside the electronic device 10. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a SD card/MMC interface, or an infrared data association (IrDA) standard interface.

The audio module 280 may bilaterally convert, for example, a sound and an electrical signal. At least some elements of the audio module 280 may be included in, for example, the input/output interface 145 illustrated in FIG. 1. The audio module 280 may process sound information which is input or output through, for example, a speaker 282, a receiver 284, earphones 286, the microphone 288, and the like.

The camera module 291 is a device which may photograph a still image and a dynamic image. According to an embodiment of the present disclosure, the camera module 291 may include one or more image sensors (e.g., a front sensor or a back sensor), a lens, an ISP or a flash (e.g., an LED or a xenon lamp).

The power management module 295 may manage, for example, power of the electronic device 10. According to an embodiment of the present disclosure, the power management module 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic method, and the like, and may further include additional circuits (e.g., a coil loop, a resonance circuit, a rectifier, and the like) for wireless charging. The battery gauge may measure, for example, a residual quantity of the battery 296, and a voltage, a current, or a temperature during the charging. The battery 296 may include, for example, a rechargeable battery or a solar battery.

The indicator 297 may indicate a particular state (e.g., a booting state, a message state, a charging state, and the like) of the electronic device 10 or a part (e.g., the processor 210) of the electronic device 10. The motor 298 may convert an electrical signal into mechanical vibration, and may generate vibration, a haptic effect, and the like. Although not illustrated, the electronic device 10 may include a processing unit (e.g., a GPU) for supporting a mobile TV. The processing unit for supporting mobile TV may, for example, process media data according to a certain standard, such as digital multimedia broadcasting (DMB), digital video broadcasting (DVB), or mediaFLO™.

Each of the components of the electronic device according to the present disclosure may be implemented by one or more components, and the name of the corresponding component may vary depending on the type of the electronic device. The electronic device according to various embodiments of the present disclosure may include at least one of the aforementioned elements. Some elements may be omitted or other additional elements may be further included in the electronic device. In addition, some of the hardware components according to various embodiments may be combined into one entity, which may perform functions identical to those of the relevant components before the combination.

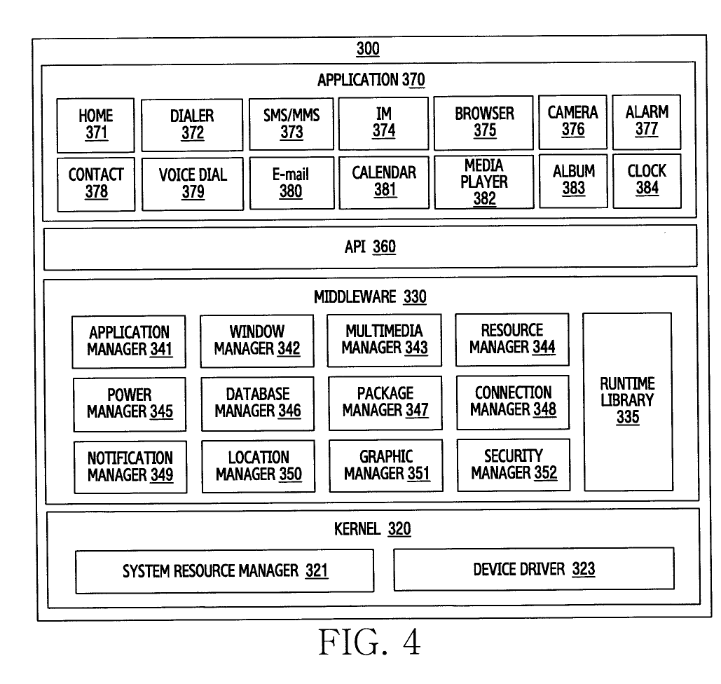

FIG. 4 illustrates a block diagram of a program module according to an embodiment of the present disclosure. Referring to FIG. 4, according to an embodiment of the present disclosure, a program module 310 (e.g., a program 140) may include an OS for controlling resources associated with an electronic apparatus (e.g., the electronic device 101) and/or various applications (e.g., an application program 147) running on the operating system. The OS may be, for example, Android, iOS, Windows, Symbian, Tizen, Bada, and the like.

The program module 310 may include a kernel 320, middleware 330, an API 360, and/or an application 370. At least a part of the program module 310 can be preloaded on the electronic device (e.g., electronic device 101) or downloaded from the server.

The kernel 320 (e.g., the kernel 141) may include, for example, a system resource manager 321 or a device driver 323. The system resource manager 321 may control, allocate, or collect the system resources. According to an embodiment of the present disclosure, the system resource manager 321 may include a process management unit, a memory management unit, a file system management unit, and the like. The device driver 323 may include, for example, a display driver, a camera driver, a BT driver, a shared-memory driver, a USB driver, a keypad driver, a Wi-Fi driver, an audio driver, an inter-process communication (IPC) driver, and the like. According to an embodiment of the present disclosure, a Wi-Fi driver of the kernel 320 may control at least one of an antenna mode or a transmission period of a network control message for use to transmit and receive signals to and from the communication interface 170.

The middleware 330 may provide, for example, a function commonly required by the applications 370 in common or provide various functions to the applications 370 through the API 360 so that the applications 370 can efficiently use limited system resources within the electronic device. According to an embodiment of the present disclosure, the middleware 330 (e.g., the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add new functions through a programming language while the application 370 is executed. The run time library 335 may perform input/output management, memory management, or a function for an arithmetic function.

The application manager 341 may manage, for example, a life cycle of at least one of the applications 370. The window manager 342 may manage graphical user interface (GUI) resources used by a screen. The multimedia manager 343 may grasp formats required for the reproduction of various media files, and may perform an encoding or decoding of the media file by using a codec suitable for the corresponding format. The resource manager 344 may manage resources, such as a source code, a memory, and a storage space of at least one of the applications 370.

The power manager 345 may operate together with a basic input/output system (BIOS) to manage a battery or power and may provide power information required for the operation of the electronic device. The database manager 346 may generate, search for, or change a database to be used by at least one of the applications 370. The package manager 347 may manage the installation or the updating of applications distributed in the form of package file.

The connectivity manager 348 may manage wireless connection of, for example, Wi-Fi or BT. The notification manager 349 can display or notify of an event, such as an arrival message, a promise, a proximity notification, and the like, in such a way that does not disturb a user. The location manager 350 may manage location information of the electronic device. The graphic manager 351 may manage graphic effects to be provided to a user and user interfaces related to the graphic effects. The security manager 352 may provide all security functions required for system security or user authentication.

The middleware 330 may include a middleware module for forming a combination of various functions of the aforementioned components. The middleware 330 may provide modules specialized according to types of operating systems in order to provide differentiated functions. Further, the middleware 330 may dynamically remove some of the existing components or add new components.

The API 360 (e.g., the API 145) is, for example, a set of API programming functions, and a different configuration thereof may be provided according to an operating system. For example, with respect to each platform, one API set may be provided in a case of Android or iOS, and two or more API sets may be provided in a case of Tizen.

The applications 370 (e.g., the application programs 147) may include, for example, one or more applications which can provide functions, such as a home function 371, a dialer 372, an SMS/MMS 373, an instant message (IM) 374, a browser 375, a camera 376, an alarm 377, contacts 378, a voice dialer 379, an email 380, a calendar 381, a media player 382, an album 383, a clock 384, a healthcare function (e.g., to measure exercise burnt calorie, or blood sugar), or an environment information (e.g., an atmospheric pressure, humidity, temperature information, and the like).

According to an embodiment of the present disclosure, the application 370 may include an application (hereinafter, for convenience of explanation, “Information Exchange application”) that supports the exchange of information between the electronic device (e.g., the electronic device 101) and the external electronic device. The application associated with exchanging information may include, for example, a notification relay application for notifying an external electronic device of certain information or a device management application for managing an external electronic device.

For example, a notification relay application may include a function of transferring the notification information generated by other applications (e.g., an SMS/MMS application, an e-mail application, a healthcare application, an environmental information application, and the like) of the electronic device to the external electronic device. Further, the notification relay application may receive notification information from, for example, the external electronic device and provide the received notification information to the user. For example, the device management application may manage (e.g., install, delete, or update) at least one function (e.g., turning on/off the external electronic device itself (or some elements thereof) or adjusting the brightness (or resolution) of a display) of the external electronic device communicating with the electronic device, applications operating in the external electronic device, or services (e.g., a telephone call service or a message service) provided from the external electronic device.

According to an embodiment of the present disclosure, the application 370 may include an application (e.g., a health management application) specified according to an attribute (e.g., as an attribute of the electronic device, the type of electronic device is a mobile medical equipment) of the external electronic device. According to an embodiment of the present disclosure, the application 370 may include an application received from the external electronic device (e.g., a server, an electronic device, and the like). According to an embodiment of the present disclosure, the applications 370 may include a preloaded application or a third party application which can be downloaded from the server. The names of the elements of the program module 310, according to the embodiment illustrated in FIG. 4, may vary according to the type of operating system.

According to various embodiments of the present disclosure, at least a part of the program module 310 may be implemented in software, firmware, hardware, or a combination of two or more thereof. At least a part of the program module 310 can be implemented (e.g., executed), for example, by a processor (e.g., by an application program). At least some of the program module 310 may include, for example, a module, program, routine, sets of instructions, or process for performing one or more functions.

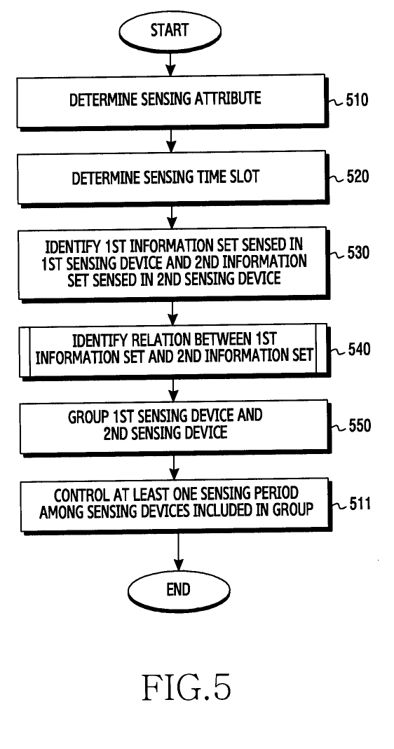

FIG. 5 is a flowchart illustrating an operation of controlling a sensing period of the sensing device 20 by the electronic device 10 according to an embodiment of the present disclosure.

Referring to FIG. 5, in operation 510, the electronic device 10 (e.g., the processor 12) may determine/select a sensing attribute (temperature, humidity, illumination, presence/absence of a user, altitude, acceleration, etc.). Responsive to operation 510, the electronic device 10 controls the sensing time period or frequency of the attribute selected in 510.

The sensing attribute may be a type of sensing values sensed by the sensing devices 20, such as a temperature, a humidity, an illumination, a presence/absence of a user, or the like. Further, the sensing attribute may be a type of context based on the sensing value sensed by the sensing devices 20. For example, if the context is energy, the sensing attribute may be a temperature, a power consumption amount, a sunshine amount, or the like, or may be a combination of more than one of them. Alternatively, if the context is an observation, the sensing attribute may be a distance sensing value, camera capturing information, door on/off information, or the like, or may be a combination of more than one of them.

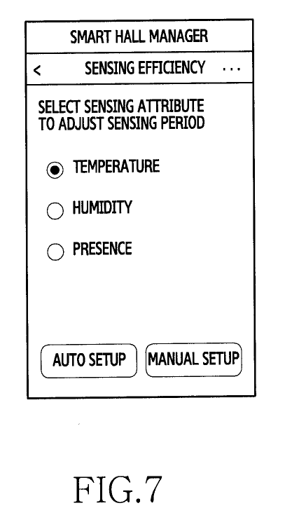

The sensing attribute may be selected and determined, for example, by a user of the electronic device 10, the processor 12 of the electronic device 10, an external remote device (not shown), or the like. For example, as shown in FIG. 7, the electronic device 10 may provide a menu through which the user can select the sensing attribute. In this case, if the user selects the sensing attribute related to the temperature, the electronic device 10 may determine the temperature of the sensing attribute as the control target of the sensing period.

In operation 520, the electronic device 10 may determine a sensing time slot as the control target of the sensing period. The sensing time slot may include, for example, a specific time slot for every day, a specific time slot for every week, a specific time slot for a day related to a specific condition (e.g., a specific weather, a specific season, a specific month, above a specific temperature, above a specific precipitation).

More specifically, the sensing time slot may include a ‘time slot from 9:00 to 13:00 for every day’, a ‘time slot from 9:00 to 13:00 for every day from Monday to Friday’, or a ‘specific time slot for a day with a good weather’.

The time slot may be determined directly or dynamically. The sensing time slot may be selected and determined, for example, by the user of the electronic device 10, the processor 12 of the electronic device 10, or the external remote device (not shown) or the like. Alternatively, the sensing time slot may be determined on the basis of a presence pattern of the user, an operation pattern of the electronic device 10, or an external environment change (e.g., a weather change pattern) or the like.

In operation 530, the electronic device 10 may identify information sets sensed in the sensing time slot determined in operation 520 among the sensing values sensed by each of the sensing devices 20 and including sensing values corresponding the sensing attribute determined in operation 510. For example, the electronic device 10 may identify the 1^{st} information set sensed in the 1^{st} sensing device 20-1 as an analysis target. Further, the electronic device 10 may identify the 2^{nd} information set sensed in the 2^{nd} sensing device 20-2 as the analysis target.

In another embodiment, the electronic device 10 may identify information sets. The information sets may be sensed in the sensing time slot determined in operation 520 and among sensing values sensed in each of the sensing devices 20. The information sets can correspond to the sensing attribute determined in operation 510. The information sets can include the sensing values sensed in a specific sensing duration. The sensing values sensed in the specific sensing duration may be sensing values sensed, for example, within recent three months, recent one month, or recent one week, or another predetermined time.

The 1^{st} information set and the 2^{nd} information set may be written and stored in a memory of the electronic device 10, the hub device 40, or an external device (not shown) of the electronic device 10. The sensing values included in the 1^{st} information set and the 2^{nd} information set may be stored together with a sensing time or time slot. Alternatively, the sensing values included in the 1^{st} information set and the 2^{nd} information set may be stored together with surrounding environment information when sensing is performed. For example, the sensing values may be stored together with environment information including a weather when sensing is performed, a presence/absence of a user, and a usage state or the like of neighboring devices.

In certain embodiments, the processor may create a file or data structure that includes the first information set and the second information set.

The operation of identifying the 1^{st} information set and the 2^{nd} information set by the electronic device 10 may include an operation of selecting a part of information sets sensed in the sensing time slot determined in operation 520 and including sensing values corresponding to the sensing attribute determined in operation 510.

For example, if the sensing time slot is a ‘time slot from 9:00 to 13:00 for every day’ and the sensing attribute is an ‘indoor temperature’, the electronic device 10 may select sensing values of which a sensing time slot is the ‘time slot from 9:00 to 13:00 for every day’ and a sensing attribute is the ‘indoor temperature’ within recent three months as an information set which is an analysis target. Alternatively, the electronic device 10 may select sensing values of which a sensing time slot is the ‘time slot of 9:00 to 13:00 for every day’ and a sensing attribute is the ‘indoor temperature’ in any duration (e.g., from 15 days before the date of today in the previous year to 15 days after the date of today) including a date of today as the information set which is the analysis target.

In operation 540, the electronic device 10 may identify a relation between the 1^{st} information set and the 2^{nd} information set. For example, the electronic device 10 may identify the relation between the 1^{st} information set and the 2^{nd} information set on the basis of the 1^{st} information set and the 2^{nd} information set associated with the 1^{st} information set. In this case, the 2^{nd} information set associated with the 1^{st} information set may have, for example, the same or similar attribute as a sensing attribute of sensing values included in the 1^{st} information set.

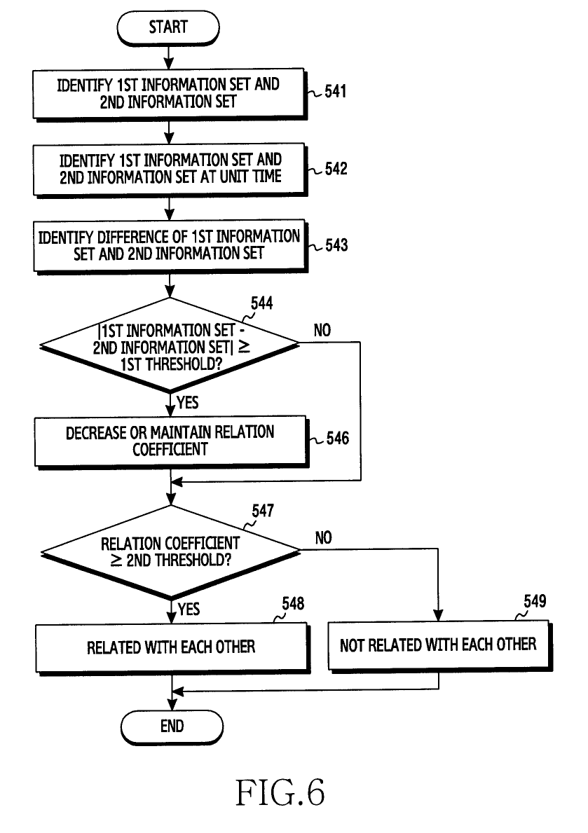

FIG. 6 is a flowchart illustrating a detailed operation of identifying a relation between a 1^{st} information set and a 2^{nd} information set by the electronic device 10.

In operation 541 of FIG. 6, the electronic device 10 may identify the 1^{st} information set and the 2^{nd} information set. The 1^{st} information set and the 2^{nd} information set may be sensing values sensed in a predetermined time slot and corresponding to a predetermined sensing attribute as described above in operation 530. For example, if the predetermined time slot is a ‘time slot from 9:00 to 13:00 for every day’ and the predetermined sensing attribute is a temperature, the electronic device 10 may identify temperature values sensed in the ‘time slot from 9:00 to 13:00 for every day among pre-stored sensing values.

In operation 542, the electronic device 10 may identify the 1^{st} information set and the 2^{nd} information set at a unit time. For example, the electronic device 10 may compare a 1^{st} sensing value included in the 1^{st} information set and a 2^{nd} sensing value included in the 2^{nd} information set at the unit time. For example, the electronic device 10 may compare the 1^{st} sensing value and the 2^{nd} sensing value which are measured at 9:00.

In this case, the electronic device 100 may identify a difference of a sensing time for at least a part of the 1^{st} information set and a sensing time for at least a part of the 2^{nd} information set. Further, if the difference of the sensing times satisfies a designated range (e.g., is less than a predetermine time offset), at least the part of the 1^{st} information set and at least the part of the 2^{nd} information set may be associated in a file or data structure created by the processor and write and stored into memory. For example, the electronic device 10 may identify a difference between a sensing time of at least one sensing value included in the 1^{st} information set and a sensing time of at least one sensing value included in the 2^{nd} information set. Further, if the difference of the sensing times satisfies the designated range, the electronic device 10 may compare at least one sensing value included in the 1^{st} information set and at least one sensing value included in the 2^{nd} information set.

Herein, the designated range may be determined according to a sensing period of the 1^{st} sensing device 20-1 for sensing the 1^{st} information set and a sensing period of the 2^{nd} sensing device 20-2 for sensing the 2^{nd} information set. For example, if the sensing period of the 1^{st} sensing device 20-1 and the sensing period of the 2^{nd} sensing device 20-2 are T, the electronic device 10 may compare the 1^{st} sensing value and 2^{nd} sensing value included in a time range T/2 as the designated range. More specifically, each of the sensing period of the 1^{st} sensing device 20-1 and the sensing period of the 2^{nd} sensing device 20-2 may be 30 minutes in the electronic device 10. In this case, if the 1^{st} sensing value sensed in the 1^{st} sensing device 20-1 is measured at 9:00 and the 2^{nd} sensing value sensed in the 2^{nd} sensing device 20-2 is measured at 9:10, a difference of the sensing times is within 15 minutes which is a T/2 time. Thus, even if two sensing values have different sensing times, the electronic device 10 may determine the two sensing values as targets to be compared with each other.

The operation of comparing the 1^{st} information set and the 2^{nd} information set by the electronic device 10 may be repetitively performed for at least one sensing value included in the 1^{st} information set and at least one sensing value included in the 2^{nd} information set which are sensed from a start time to an end time of the sensing time slot determined in operation 520.

In operation 543, the electronic device 10 may identify a difference of the 1^{st} information set and the 2^{nd} information set. For example, the electronic device 10 may identify a difference of at least one sensing value included in the 1^{st} information set and at least one sensing value included in the 2^{nd} information set. For example, if a sensing attribute of a sensing value is temperature, the electronic device 10 may identify a difference of at least one temperature value included in the 1^{st} information set and at least one temperature value included in the 2^{nd} information set.

In operation 544, the electronic device 10 may determine whether the difference of the 1^{st} information set and the 2^{nd} information set is greater than or equal to a threshold. For example, the electronic device 10 may determine whether a difference of at least one sensing value included in the 1^{st} information set and a difference of at least one sensing value included in the 2^{nd} information set is greater than or equal to a threshold.

If the determination result shows that the difference of the 1^{st} information set and the 2^{nd} information set is greater than or equal to a 1^{st} threshold (544-Y), in operation 546, the electronic device 10 may increase a relation coefficient indicating the relation between the 1^{st} information set and the 2^{nd} information set. Otherwise, if the difference of the 1^{st} information set and the 2^{nd} information set is less than the 1^{st} threshold (544-N), the electronic device 10 may decrease or maintain the relation coefficient indicating the relation between the 1^{st} information set and the 2^{nd} information set.

The 1^{st} threshold may be any pre-designated constant. Further, the 1^{st} threshold may be determined by considering a characteristic of the sensing value included in the information set and/or a characteristic (e.g., a unit of sensing, a sensing error range, or the like) of the sensing device for measuring the information set. In this case, the characteristic of the sensing value may include, for example, at least one of sensitivity for a sensing value, a sensing duration, or a deviation of the sensing value.

Further, the 1^{st} threshold may be corrected according to the sensing attribute of the sensing value. For example, if the sensing attribute of the sensing value is a temperature, the electronic device 10 may set the 1^{st} threshold to be low in an environment in which a sensitive response is achieved for the sensing value. For another example, the electronic device 10 may set the 1^{st} threshold to be low in an environment in which an average temperature difference is small. For another example, the electronic device 10 may set the 1^{st} threshold to be high in an environment in which the deviation of the sensing value is great. That is, since the relation between the 1^{st} sensing device 20-1 for sensing the 1^{st} information set and the 2^{nd} sensing device 20-2 for sensing the 2^{nd} information set is determined according to a threshold magnitude, the electronic device 10 may set the 1^{st} threshold according to the aforementioned various elements and a user's necessity, or may correct the pre-set 1^{st} threshold.

In operation 547, the electronic device 10 may determine whether the relation coefficient is greater than or equal to a 2^{nd} threshold. For example, the 2^{nd} threshold may be a coefficient for determining whether there is a relation between the sensing devices 20. For example, the 2^{nd} threshold may be a pre-designated constant.

If the determination result shows that the relation coefficient is greater than or equal to the 2^{nd} threshold (547-Y), in operation 548, the electronic device 10 may determine that the 1^{st} information set measured in the 1^{st} sensing device 20-1 and the 2^{nd} information set measured in the 2^{nd} sensing device 20-2 are related with each other. If the 1^{st} information set measured in the 1^{st} sensing device 20-1 and the 2^{nd} information set measured in the 2^{nd} sensing device 20-2 are related with each other, the processor can create a file or data structure that includes both information sets and write the file or data structure in memory.

Otherwise, if the relation coefficient is less than the 2^{nd} threshold (547-Y), in operation 549, the electronic device 10 may determine that the 1^{st} information set measured in the 1^{st} sensing device 20-1 and the 2^{nd} information set measured in the 2^{nd} sensing device 20-2 are not related with each other.

According to one embodiment, the aforementioned operations 544 to 549 may be replaced with a method of calculating an arithmetic deviation between sensing values included in the 1^{st} information set and sensing values included in the 2^{nd} information set for each unit time. For example, respective difference values of the sensing values included in the 1^{st} information set and the sensing values included in the 2^{nd} information set may be calculated for each unit time, and then a deviation between the calculated difference values may be derived. In this case, if the derived deviation is greater than or equal to a threshold, the electronic device 10 may determine that the 1^{st} information set and the 2^{nd} information set are related with each other. Otherwise, if the derived deviation is less than the threshold, the electronic device 10 may determine that the 1^{st} information set and the 2^{nd} information set are not related with each other.

For example, if the sensing attribute is temperature, the first sensing device 20-1 can be a thermometer. By way of example, the second sensing device could be a hygrometer. If it is determined that the measurements of the thermometer and the hygrometer are related, the frequency of the measurements by the thermometer can be adjusted based on the remaining battery strength of the hygrometer and the thermometer.

FIG. 7 illustrates a graphical user interface wherein the user can selectively input a particular attribute from a screen of menus. Although in this example, the menus for “temperature”, “humidity”, and “presence” are shown, it shall be understood that a variety of other attributes can be selected from. The graphical user interface can be displayed on a touchscreen wherein the user can select the attribute by touching the screen substantially near the menu associated with the desired attribute. For example, user selection of the attribute can correspond to 510 in FIG. 5.

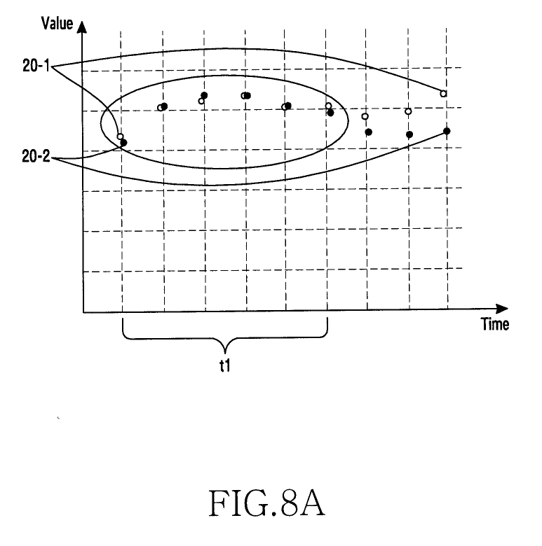

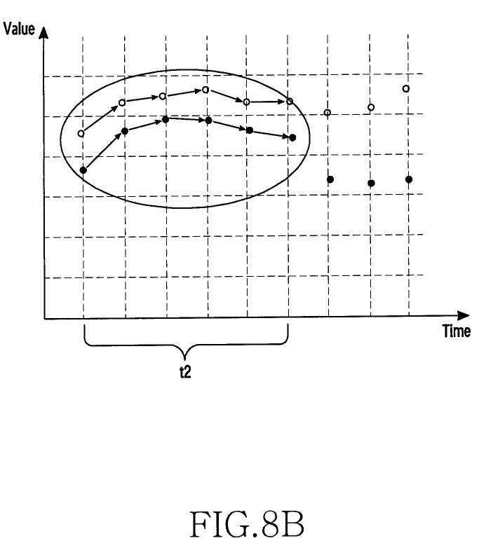

FIG. 8A and FIG. 8B are graphs illustrating sensing values measured in the sensing devices 20 according to an embodiment of the present disclosure.

In the graphs of FIG. 8A and FIG. 8B, an X-axis may represent time, and a Y-axis may represent a sensing value. Further, points on the graph represent the 1^{st} information set sensed in the 1^{st} sensing device 20-1 and the 2^{nd} information set sensed in the 2^{nd} sensing device 20-2.

The electronic device 10 may compare a change pattern of the 1^{st} information set sensed in the 1^{st} sensing device 20-1 and a change pattern of the 2^{nd} information set sensed in the 2^{nd} sensing device 20-2. The comparing of the change patterns may include, for example, whether a difference between the sensing values included in the 1^{st} information set and sensing values included in the 2^{nd} information set, a change amount, a standard deviation, a variance, a Coefficient of Variation (CV), a range indicating a difference between a maximum value and a minimum value are less than or equal to a threshold, sum of absolute differences, sum of squared absolute differences.

For example, as shown in FIG. 8A, if sensing values included in the 1^{st} information set and sensing values included in the 2^{nd} information set, which are sensed at a specific time slot t1, have the same difference or have a difference less than or equal to a threshold, the electronic device 10 may determine that the 1^{st} information set and the 2^{nd} information set are related with each other.

Alternatively, as shown in FIG. 8B, if sensing values included in the 1^{st} information set and sensing values included in the 2^{nd} information set, which are sensed at a specific time slot t2, have the same change amount or change pattern or have a difference less than or equal to a threshold, the electronic device 10 may determine that the 1^{st} information set and the 2^{nd} information set are related with each other. Accordingly, in some embodiments, the correlations can be based on the derivatives of the information sets.

Again, in FIG. 5, if it is determined that the 1^{st} information set sensed in the 1^{st} sensing device 20-1 and the 2^{nd} information set sensed in the 2^{nd} sensing device 20-2 are related with each other, in operation 550, the electronic device 10 may group the 1^{st} sensing device 20-1 and the 2^{nd} sensing device 20-1 among the plurality of sensing devices 20 operatively coupled with the electronic device 10 on the basis of the determined relation.

For example, as described above with reference to FIG. 8A and FIG. 8B, if a 1^{st} change pattern of the 1^{st} information set and a 2^{nd} change pattern of the 2^{nd} information set have a different less than or equal to a threshold, the electronic device 10 may group the 1^{st} sensing device for sensing the 1^{st} information set and the 2^{nd} sensing device for sensing the 2^{nd} information set.

Meanwhile, if the 1^{st} sensing device 20-1 and the 2^{nd} sensing device 20-2 are grouped, the electronic device 10 may add the 3^{rd} sensing device 20-3 which is different from the 1^{st} sensing device 20-1 and the 2^{nd} sensing device 20-2 to the group among the plurality of sensing devices 20 by repeating the process of operations 510 to 540 of FIG. 5.

If the 1^{st} sensing device 20-1 and the 2^{nd} sensing device 20-2 are grouped, in operation 560, the electronic device 10 may control at least one sensing period among the sensing devices included in the group. For example, the electronic device 10 may determine at least one sensing period between the 1^{st} sensing device 20-1 and 2^{nd} sensing device 20-2 included in the group. Further, the electronic device 10 may transmit a command for requesting at least one of the 1^{st} sensing device 20-1 and the 2^{nd} sensing device 20-1 to perform sensing according to the determined sensing period.

According to one embodiment, the electronic device 10 may determine a sensing period of at least one sensing device 20 such that at least one sensing device 20 between the 1^{st} sensing device 20-1 and the 2^{nd} sensing device 20-2 does not transmit to-be-sensed information to the electronic device 10 at a designated time. Further, the electronic device 10 may transmit to the at least one sensing device 20 the command for requesting at least one sensor to sense the surrounding environment according to the determined sensing period.

According to one embodiment, the electronic device 10 may determine a sensing period of at least one sensing device 20 such that at least one sensing device 20 between the 1^{st} sensing device 20-1 and the 2^{nd} sensing device 20-2 does not sense a surrounding environment at the designated time. Further, the electronic device 10 may transmit to the at least one sensing device 20 a command for requesting the at least one sensing device 20 to sense the surrounding environment at the designated time.

According to another embodiment, the electronic device 10 may determine a 1^{st} sensing period and a 2^{nd} sensing period/frequency as a plurality of sensing periods for at least one sensing device between the 1^{st} sensing device 20-1 and the 2^{nd} sensing device 20-2. Further, the electronic device 10 may transmit a command for requesting at least one sensing device 20 between the 1^{st} sensing device 20-1 and the 2^{nd} sensing device 20-2 to perform sensing with the 1^{st} sensing period. Furthermore, when the designated time elapses, the electronic device 10 may transmit a command for requesting the at least one sensing device 20 between the 1^{st} sensing device 20-1 and the 2^{nd} sensing device 20-2 to perform sensing with the 2^{nd} sensing period which is different from the 1^{st} sensing period.

According to another embodiment, the electronic device 10 may determine at least one sensing period among the sensing devices 20 included in the group on the basis of the existing sensing period of each of the sensing devices 20 included in the group and the number of sensing devices 20 included in the group. Further, the electronic device 10 may transmit to at least one sensing device 20 the command for requesting the at least one sensing device 20 to sense the surrounding environment according to the determined sensing period.

According to another embodiment, the electronic device 10 may determine at least one sensing period among the sensing devices 20 included in the group on the basis of the existing sensing period of each of the sensing devices 20 included in the group, the number of sensing devices 20 included in the group, and battery information of each of the sensing devices 20 included in the group. Further, the electronic device 10 may transmit to at least one sensing device 20 the command for requesting the at least one sensing device 20 to sense the surrounding environment according to the determined sensing period.

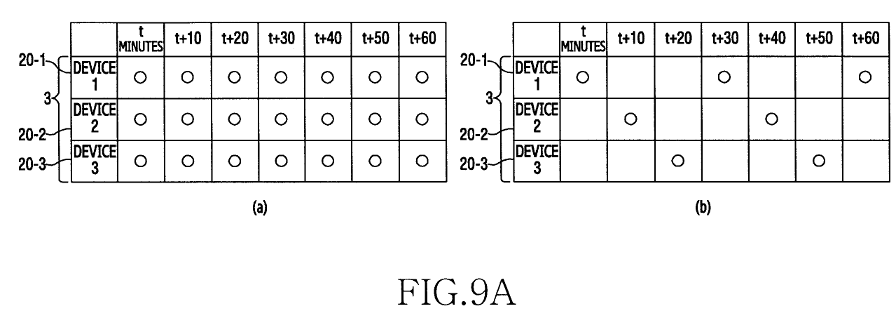

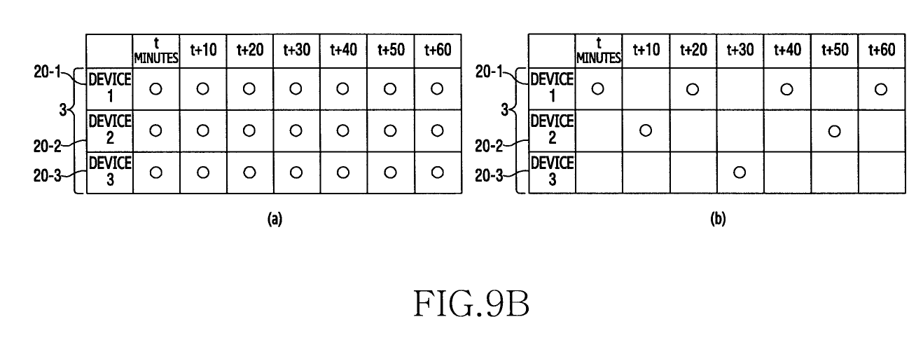

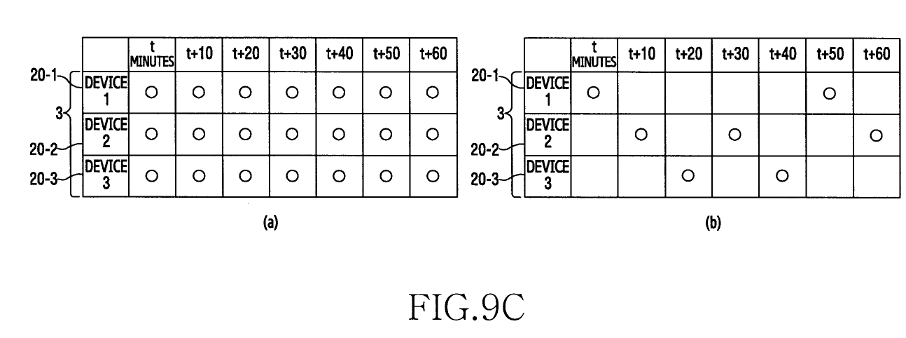

FIG. 9A to FIG. 9C are tables illustrating a sensing times of each of the sensing devices 20 before/after the electronic device 10 determines the sensing period.

In FIG. 9A, (a) is a table illustrating a sensing period of the sensing devices 20 before the electronic device 10 determines the sensing period, and (b) is a table illustrating a sensing period of the sensing devices 20 after the electronic device 10 determines the sensing period.

In (a) of FIG. 9A, the existing sensing period of sensing devices 20-1, 20-2, and 20-3 included in a group 3 may be 10 minutes, and the number of the sensing devices 20-1, 20-2, and 20-3 included in the group 3 may be 3. In this case, the electronic device 10 may determine a sensing period such that a sensing time at which the sensing devices 20-1, 20-2, and 20-3 sense a surrounding environment is different. For example, as shown in (b) of FIG. 9A, the electronic device 10 may determine the sensing period of the sensing devices 20-1, 20-2, and 20-3 to 30 minutes, and may determine the sensing period of the sensing devices 20-1, 20-2, and 20-3 such that a sensing start time is an interval of 10 minutes.

Accordingly, sensing values sensed by the sensing devices 20-1, 20-2, and 20-3 included in the group have the same sensing attribute, and a sensing period can be increased to minimize redundant measurement of the sensing value of the sensing devices 20-1, 20-2, and 20-3 in a situation in which the sensing devices 20 have a similar surrounding environment. Therefore, battery consumption of the sensing devices 20 is decreased, which may lead to an increase in an operation duration of the sensing devices 20-1, 20-2, and 20-3.

In FIG. 9B and FIG. 9C, (a) is a table illustrating a sensing period of the sensing devices 20 before the electronic device 10 controls the sensing period, and (b) is a table illustrating a sensing period of the sensing devices 20 after the electronic device 10 controls the sensing period.

In (a) of FIG. 9B and (a) of FIG. 9C, the existing sensing period of sensing devices 20-1, 20-2, and 20-3 included in a group 3 may be staggered by 10 minutes, and the number of the sensing devices 20-1, 20-2, and 20-3 included in the group 3 may be 3. In this case, the electronic device 10 may be determined on the basis of a state of the sensing devices 20-1, 20-2, and 20-3 and a surrounding environment of the sensing devices 20-1, 20-2, and 20-3. For example, the electronic device 10 may determine the sensing period of the sensing devices 20 on the basis of at least one of a battery remaining amount and a battery consumption amount of the sensing devices 20-1, 20-2, and 20-3 included in the group.

For example, if the battery remaining amount of the 1^{st} sensing device 20-1 is twice the battery remaining amount of the 2^{nd} sensing device 20-2 and the 3^{rd} sensing device 20-3, as shown in (b) of FIG. 9B, the electronic device 10 may determine a sensing occurrence rate of the 1^{st} sensing device 20-1, the 2^{nd} sensing device 20-2, and the 3^{rd} sensing device 20-3 as 2:1:1.

For another example, if the battery consumption amount of the 1^{st} sensing device 20-1 is twice the battery consumption amount of the 2^{nd} sensing device 20-2 and the 3^{rd} sensing device 20-3, as shown in (b) of FIG. 9C, the electronic device 10 may determine a sensing occurrence rate of the 1^{st} sensing device 20-1, the 2^{nd} sensing device 20-2, and the 3^{rd} sensing device 20-3 as 1:2:2.

As such, since the sensing period of the sensing devices 20 is determined on the basis of the battery remaining amount, the battery consumption of the sensing devices 20 having the least battery remaining amount may be decreased, which may lead to an increase in an average operation duration of the sensing devices 20.

Upon determining of at least one sensing period between the 1^{st} sensing device 20-1 and the 2^{nd} sensing device 20-2, the electronic device 10 may transmit a command for requesting at least one sensing device 20 between the 1^{st} sensing device 20-1 and the 2^{nd} sensing device 20-2 to perform sensing according to the determined sensing period. In this case, the command for requesting the at least one sensing device 20 to perform sensing according to the determined sensing period may include an operation condition of the sensing period, in addition to the sensing period. As group information, the command for requesting to perform sensing according to the sensing period may include information of the sensing devices 20 included in the group.

The operation condition of the sensing period may be at least one of time information, weather information, and environment information to which the sensing period is applied. Further, the operation condition of the sensing period may be transmitted by including information used to determine the sensing period.

Accordingly, the at least one sensing device 20 may sense a surrounding environment according to the sensing period under the operation condition of the received sensing period, and upon occurrence of a situation in which the received operation condition is not satisfied, may request the electronic device 10 to release the group. In this case, the electronic device 10 which has received the group release request may transmit a command for requesting the sensing devices 20 included in the group not to apply the determined sensing period.

Alternatively, the electronic device 10 may receive a sensing value according to the operation condition from the at least one sensing device 20, and upon occurrence of a situation in which the at least one sensing device 20 cannot satisfy the operation condition, may transmit the command for requesting to the sensing devices 20 included in the group not to apply the determined sensing period.

Meanwhile, if the at least one sensing device 20 cannot perform sensing according to the operation condition of the received sensing period due to a restriction of an equipped sensor, the at least one sensing device 20 may receive information necessary for the operation condition of the sensing period from neighboring devices. For example, if temperature information is required as the operation condition of the sensing period, the at least one sensing device 20 may receive the temperature information from another sensing device.

The sensing period transmitted by the electronic device 10 to the sensing device 20 may include an absolute sensing time or a relative sensing time.

For example, as shown in Table 1 below, the sensing period may include an absolute sensing time of each of the sensing devices 20 included in the group.

TABLE 1

| | The sensing period |
|---|---|
| A device 1 | 09:00, 09:30, 10:00, 10:30, 11:00, 11:30, 12:00, 12:30, |
| | 13:00 |
| A device 2 | 09:10, 09:40, 10:10, 10:40, 11:10, 11:40, 12:10, 12:40 |
| A device 3 | 09:20, 09:50, 10:20, 10:50, 11:20, 11:50, 12:20, 12:50 |

Alternatively, as shown in Table 2 below, the sensing period may include a sensing time slot and a sensing period of a minute unit to be applied to the sensing time slot.

TABLE 2

| | The sensing time slot | The sensing period |
|---|---|---|
| A device 1 | 09:00-13:00 | xx: 00, xx: 30 |
| A device 2 | 09:00-13:00 | xx: 10, xx: 40 |
| A device 3 | 09:00-13:00 | xx: 20, xx: 50 |

Alternatively, if the sensing devices 20 do not have a time checking function, the electronic device 10 may differently set a time of transmitting the command for requesting the sensing devices 20 to perform sensing. Alternatively, the electronic device 10 may differently set a time of starting the sensing while transmitting the time of starting the sensing separately to the sensing devices 20.

For example, as shown in Table 3 below, the electronic device 10 may transmit a sensing request including a sensing period while differently setting the time of transmitting the command for requesting each of the sensing devices 20 to perform the sensing.

TABLE 3

| | The transmission time (to a device) | The sensing period |
|---|---|---|
| A device 1 | 09:00 | 30 min |
| A device 2 | 09:10 | 30 min |
| A device 3 | 09:20 | 30 min |

Alternatively, if the sensing devices 20 do not have the time checking function, the electronic device 10 may differently set a time of starting sensing while separately transmitting the time of starting the sensing to each of the sensing devices 20.

For example, as shown in Table 4 below, the electronic device 10 may transmit a sensing request command including a sensing start time or a sensing standby time and a sensing period while differently setting the sensing start time for each of the sensing devices 20 after receiving the sensing request command.

TABLE 4

| | The sensing | The sensing | Additional |
|---|---|---|---|
| | start time | period | Information |
| A device 1 | 0 min | 30 min | immediately sensing, |
| | | | then sensing each 30 |
| | | | min |
| A device 2 | 10 min | 30 min | sensing after 10 min, |
| | | | then sensing each 30 |
| | | | min |
| A device 3 | 20 min | 30 min | sensing after 20 min, |
| | | | then sensing each 30 |
| | | | min |

At least one sensing device 20 which has received the command for requesting to perform sensing according to the determined sensing period from the electronic device 10 may sense a surrounding environment according to the sensing period included in the command. Further, the at least one sensing device 20 may transmit a sensing value to the electronic device 10 as a sensing result.

Meanwhile, the sensing device 20 may transmit the sensing value to the electronic device 10, and may enter a standby mode or a sleep mode until a next sensing time based on the sensing period. In this case, the sensing device 20 may not perform a relay operation for transmitting to a different external device a message received from another external device. That is, if the sensing device 20 is a constitutional element of a mesh network for message delivery, the sensing device 20 may not perform an operation as the constitutional element of the mesh network in the standby mode or the sleep mode. Accordingly, battery consumption of the sensing device 20 may be significantly decreased.

[Table 5 correspond to FIG. 9B. b]

| | The sensing | The sensing | Additional |
|---|---|---|---|
| | start time | period | Information |
| A device 1 | 0 min | 20 min | immediately sensing, |
| | | | then sensing each 20 |
| | | | min |
| A device 2 | 10 min | 40 min | sensing after 10 min, |
| | | | then sensing each 40 |
| | | | min |
| A device 3 | 30 min | 40 min | sensing after 30 min, |
| | | | then sensing each 40 |
| | | | min |

[Table 6 correspond to FIG. 9C, b]

| | The sensing | The | Additional |
|---|---|---|---|
| | start time | sensing period | Information |
| A device 1 | 0 min | 50 min | immediately sensing, |
| | | | then sensing each 50 |
| | | | min |
| A device 2 | 10 min | 20/30 min | sensing after 10 min, |
| | | | then sensing, |
| | | | alternatingly each 20 |
| | | | and 30 min |
| A device 3 | 20 min | 20/30 min | sensing after 20 min, |
| | | | then sensing, |
| | | | alternatingly each 20 |
| | | | and 30 min |

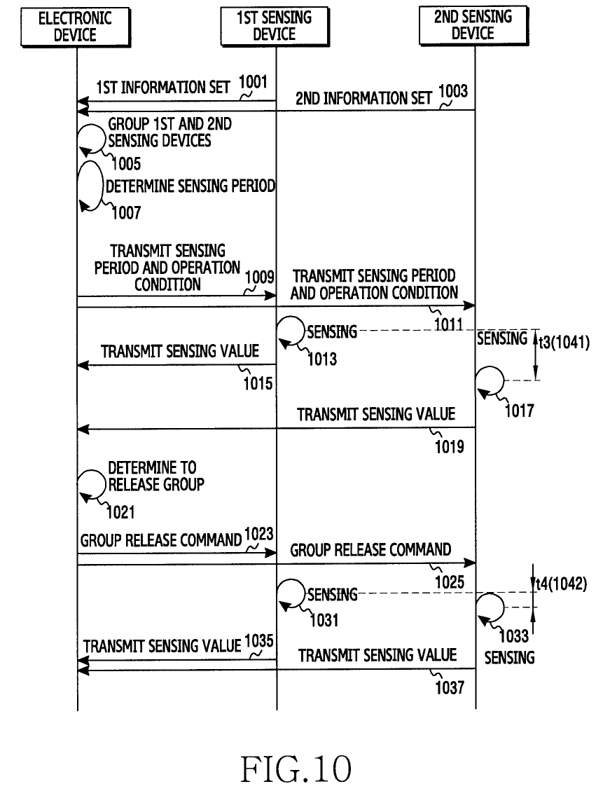

FIG. 10 is a flowchart illustrating a process of controlling a sensing period of the sensing device 20 by the electronic device 10 according to an embodiment of the present disclosure.

In operation 1001 and operation 1003 of FIG. 10, the electronic device 10 may receive a 1^{st} information set including a plurality of sensing values from the 1^{st} sensing device (e.g., the 1^{st} sensing device 20-1 of FIG. 1A or 1B), and may receive a 2^{nd} information set including a plurality of sensing values from the 2^{nd} sensing device (e.g., the 1^{st} sensing device 20-2 of FIG. 1A or 1B). Alternatively, the electronic device 10 may generate the 1^{st} information set by receiving the plurality of sensing values from the 1^{st} sensing device 20-1, and may generate the 2^{nd} information set by receiving the plurality of sensing values from the 2^{nd} sensing device 20-2.

In operation 1005, upon determining that the 1^{st} information set and the 2^{nd} information set are related with each other, the electronic device 10 may group the 1^{st} sensing device 20-1 and the 2^{nd} sensing device 20-2.

In operation 1007, the electronic device 10 may determine a sensing period of the 1^{st} sensing device 20-1 and a sensing period of the 2^{nd} sensing device 20-2 included in the group.

Upon determining the sensing period, in operation 1009 and operation 1011, the electronic device 10 may transmit a sensing period and an operation condition of the sensing period to the 1^{st} sensing device 20-1 and the 2^{nd} sensing device 20-2.

In response thereto, the 1^{st} sensing device 20-1 and the 2^{nd} sensing device 20-2 may perform sensing at different times.

Further, the 1^{st} sensing device 20-1 and the 2^{nd} sensing device 20-2 may transmit a collected sensing value to the electronic device 10. In this case, the 1^{st} sensing device 20-1 and the 2^{nd} sensing device 20-2 may transmit the sensing value to the electronic device 10 at different times, or may transmit it to the electronic device 10 at the same time.

For example, in operation 1013, the 1^{st} sensing device 20-1 may perform sensing of a surrounding environment at a 1^{st} time. Next, in operation 1015, the 1^{st} sensing device 20-1 may transmit the collected sensing value to the electronic device 10. Further, in operation 1017, the 2^{nd} sensing device 20-2 may perform the sensing of the surrounding environment at a 2^{nd} time having a time difference of t3 1041 from the 1^{st} time. Next, in operation 1019, the 2^{nd} sensing device 20-2 may transmit the collected sensing value to the electronic device 10.

In this situation, at least one of the 1^{st} sensing device 20-1 and the 2^{nd} sensing device 20-2 may not be able to satisfy an operation condition of a sensing period due to a change in a surrounding environment of at least one of the 1^{st} sensing device 20-1 and the 2^{nd} sensing device 20-2.

In this case, in operation 1021, the electronic device 10 may determine to release the group including the 1^{st} sensing device 20-1 and the 2^{nd} sensing device 20-2.

Further, in operation 1023 and operation 1025, the electronic device 10 may transmit a group release command to each of the 1^{st} sensing device 20-1 and the 2^{nd} sensing device 20-2.

Upon receiving the group release command, the 1^{st} sensing device 20-1 and the 2^{nd} sensing device 20-2 may perform sensing according to the existing sensing period.

For example, in operation 1031, the 1^{st} sensing device 20-1 may perform sensing of the surrounding environment at a 3^{rd} time. Further, in operation 1033, the 2^{nd} sensing device 20-2 may perform the sensing of the surrounding environment at a 4^{th} time.

In this case, the 1^{st} sensing device 20-1 and the 2^{nd} sensing device 20-2 may have the same or almost the same sensing time. For example, if the 1^{st} sensing device 20-1 and the 2^{nd} sensing device 20-2 have almost the same sensing time, a time difference of t4 1042 may exist between the 1^{st} time and the 2^{nd} time. In this case, the time of t4 1042 may be shorter than the time of t3 1041.

Next, in operation 1035, the 1^{st} sensing device 20-1 may transmit the collected sensing value to the electronic device 10. Further, in operation 1037, the 2^{nd} sensing device 20-2 may transmit the collected sensing value to the electronic device 10.

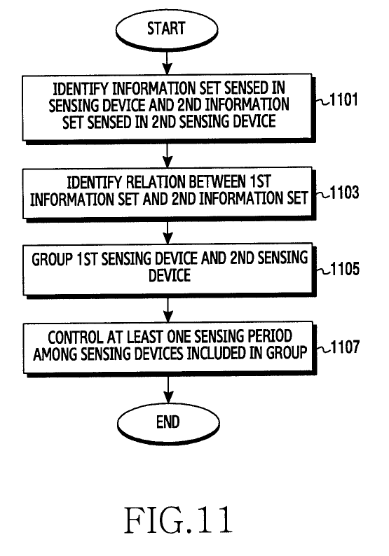

FIG. 11 is a flowchart illustrating a process of controlling a sensing period of the sensing device 20 by the electronic device 10 according to another embodiment of the present disclosure.

In operation 1101, the electronic device 10 may identify a 1^{st} information set sensed by using the 1^{st} sensing device 20-1, and may identify a 2^{nd} information set sensed by using the 2^{nd} sensing device 20-2.

In operation 1103, the electronic device 10 may identify a relation between the 1^{st} information set and the 2^{nd} information set, on the basis of comparison between the 1^{st} information set and the 2^{nd} information set associated with the 1^{st} information.

For example, the electronic device 10 may identify a difference between a sensing time for at least a part of the 1^{st} information set and a sensing time for at least a part of the 2^{nd} information set. Further, if the identified difference satisfies a designated range, at least the part of the 1^{st} information set and at least the part of the 2^{nd} information set may be associated.

Alternatively, the electronic device 10 may compare a change pattern of the 1^{st} information set and a change pattern of the 2^{nd} information set to identify the relation between the 1^{st} information set and the 2^{nd} information set.

In operation 1105, the electronic device 10 may select and group the 1^{st} sensing device 20-1 and the 2^{nd} sensing device 20-2 among the plurality of sensing devices 20 on the basis of the relation.

For example, the electronic device 10 may group the 1^{st} sensing device 20-1 and the 2^{nd} sensing device 20-2 if the difference between the 1^{st} change pattern and the 2^{nd} change pattern is less than or equal to a threshold.

In operation 1107, the electronic device 10 may control a sensing period of at least one sensing device 20 included in the group.

For example, the electronic device 10 may determine the sensing period of the at least one sensing device 20 such that the sensing devices 20 included in the group have different sensing times for sensing a surrounding environment.

Alternatively, the electronic device 10 may determine the sensing period of the at least one sensing device 20 such that the at least one sensing device 20 does not transmit to-be-sensed information to the electronic device 10 at the designated time.

Alternatively, the electronic device 10 may transmit to the at least one sensing device 20 a command for requesting at least one sensing device to sense the surrounding environment according to the determined sensing period. In this case, the command for requesting to sense the surrounding environment may include the sensing period of the at least one sensing device 20 and an operation condition of the sensing period.

Alternatively, the electronic device 10 may transmit to the at least one sensing device 20 a command for requesting at least one sensing device to perform sensing with a 1^{st} sensing period. Further, when the designated time elapses, a command for requesting the at least one sensing device to perform sensing with a 2^{nd} sensing period different from the 1^{st} sensing period may be transmitted to the at least one sensing device 20.

According to various embodiments of the present disclosure, a sensing period of a sensing device is controlled to increase a battery duration time of the sensing device and to minimize memory capacity of the sensing device for storing a sensing value.

According to various embodiments of the present disclosure, battery consumption of the sensing device is decreased to increase an operation duration of the sensing device, thereby expecting robustness of an IoT environment.

On the other hand, effects obtained or predicted by the embodiments of the present disclosure will be directly or suggestively disclosed in the detailed description of the embodiment of the present disclosure. For example, various effects predicted according to the embodiments of the present disclosure will be disclosed in the detailed description of the embodiments of the present disclosure as follows.

The term “module” as used herein may, for example, mean a unit including one of hardware, a combination of hardware and software, and firmware embedded into hardware, or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGAs), and a programmable-logic device for performing operations which has been known or are to be developed hereinafter.

At least some of the devices (e.g., modules or functions thereof) or the method (e.g., operations) according to various embodiments may be implemented by, for example, a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

According to various embodiments, there is provided a storage medium for storing instructions. When the instructions are executed by at least one processor, the at least one processor may be allowed to perform at least one operation. The at least one operation may include, in an electronic device operatively coupled to a plurality of sensing devices 20 including a 1^{st} sensing device 20-1 and a 2^{nd} sensing device 20-2, identifying a 1^{st} information set by using the 1^{st} sensing device, identifying a 2^{nd} information set sensed by using the 2^{nd} sensing device 20-2, identifying a relation between the 1^{st} information set and the 2^{nd} information set on the basis of comparison between the 1^{st} information set and the 2^{nd} information set associated with the 1^{st} information set, grouping the 1^{st} sensing device 20-1 and the 2^{nd} sensing device 20-2 by selecting from among the plurality of sensing devices 20 on the basis of the relation, and controlling a sensing period of at least one sensing device 20 included in the group.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method performed in an electronic device, the method comprising:
in the electronic device operatively coupled to a plurality of sensing devices comprising a 1^{st} sensing device and a 2^{nd} sensing device, identifying a 1^{st} information set by using the 1^{st} sensing device;
identifying a 2^{nd} information set sensed by using the 2^{nd} sensing device;
determining a correlation between the 1^{st} information set and the 2^{nd} information set based on a comparison between the 1^{st} information set and the 2^{nd} information set;
grouping the 1^{st} sensing device and the 2^{nd} sensing device based on the correlation; and
controlling a sensing period of at least one of the 1^{st} sensing device and the 2^{nd} sensing device.

2. The method of claim 1, wherein the controlling of the sensing period comprises changing the sensing period of the at least one of the 1^{st} and 2^{nd} sensing devices such that a sensing time for sensing a surrounding environment is different from an initial sensing period of the at least one of the 1^{st} and 2^{nd} sensing devices.

3. The method of claim 1, wherein the determining the correlation between the 1^{st} information set and the 2^{nd} information set comprises:
identifying a difference between a sensing time for at least a part of the 1^{st} information sent and a sensing time for at least a part of the 2^{nd} information set; and
if the difference satisfies a designated range, associating at least the part of the 1^{st} information set with at least the part of the 2^{nd} information set.

4. The method of claim 1, wherein determining the correlation between the 1^{st} information set and the 2^{nd} information set comprises comparing a 1^{st} change pattern of the 1^{st} information set with a 2^{nd} change pattern of the 2^{nd} information set.

5. The method of claim 1, wherein the grouping of the selected 1^{st} sensing device and 2^{nd} sensing device comprises grouping the 1^{st} sensing device and the 2^{nd} sensing device if the difference between the 1^{st} change pattern and the 2^{nd} change pattern is less than or equal to a threshold.

6. The method of claim 1, wherein the controlling of the sensing period of the at least one sensing device comprises determining a sensing period of the at least one sensing device such that the at least one sensing device does not transmit to-be-sensed information to the electronic device at a designated time.

7. The method of claim 1, wherein the controlling of the sensing period of the at least one of the 1^{st} and 2^{nd} sensing devices comprises transmitting to the at least one of the 1^{st} and 2^{nd} sensing devices a command for requesting the at least one of the 1^{st} and 2^{nd} sensing devices to sense a surrounding environment according to the changed sensing period.

8. The method of claim 7, wherein the command for requesting the at least one of the 1^{st} and 2^{nd} sensing devices to sense the surrounding environment according to the changed sensing period comprises a sensing period of the at least one of the 1^{st} and 2^{nd} sensing devices and an operation condition of the sensing period.

9. The method of claim 1, wherein the controlling of the sensing period of the at least one sensing device comprised in the group comprises:
transmitting to the at least one of the 1^{st} and 2^{nd} sensing devices a command for requesting the at least one of the 1^{st} and 2^{nd} sensing devices to perform sensing with a 1^{st} sensing period; and
transmitting to the at least one sensing device a command for requesting the at least one of the 1^{st} and 2^{nd} sensing devices to perform sensing with a 2^{nd} sensing period different from the 1^{st} sensing period when a designated time elapses.

10. The method of claim 1, further comprising
determining at least one of a sensing attribute and a sensing time slot as a control target of the sensing period of the sensing device,
wherein the identifying of the 1^{st} information set and the 2^{nd} information set comprises identifying an information set comprising a sensing value corresponding at least one of the determined sensing attribute and sensing time slot.

11. An electronic device comprising:
a communication module operatively coupled to a plurality of sensing devices comprising a 1^{st} sensing device and a 2^{nd} sensing device; and
a processor, wherein the processor is configured for:
identifying a 1^{st} information set sensed by using the 1^{st} sensing device and a 2^{nd} information set sensed by using the 2^{nd} sensing device,
determining a correlation between the 1^{st} information set and the 2^{nd} information set based on a comparison between the 1^{st} information set and the 2^{nd} information set;
grouping the 1^{st} sensing device and the 2^{nd} sensing device based on the correlation; and
controlling a sensing period of at least one of the 1^{st} sensing device and the 2^{nd} sensing device.

12. The electronic device of claim 11, wherein in case of controlling the sensing period, the processor is configured for changing the sensing period of the at least one sensing device such that a sensing time for sensing a surrounding environment is different from an initial sensing period of the at least one of the 1^{st} and 2^{nd} sensing devices.

13. Thee electronic device of claim 11, wherein in case of determining the correlation between the 1^{st} information set and the 2^{nd} information set, the processor is configured for identifying a difference between a sensing time for at least a part of the 1^{st} information sent and a sensing time for at least a part of the 2^{nd} information set, and if the difference satisfies a designated range, associating at least the part of the 1^{st} information set with at least the part of the 2^{nd} information set.

14. Thee electronic device of claim 11, wherein in case of determining the correlation between the 1^{st} information set and the 2^{nd} information set, the processor is configured for comparing a 1^{st} change pattern of the 1^{st} information set with a 2^{nd} change pattern of the 2^{nd} information set.

15. The electronic device of claim 11, wherein in case of grouping of the selected 1^{st} sensing device and 2^{nd} sensing device, the processor is configured for grouping the 1^{st} sensing device and the 2^{nd} sensing device if the difference between the 1^{st} change pattern and the 2^{nd} change pattern is less than or equal to a threshold.

16. Thee electronic device of claim 11, wherein in case of controlling the sensing period of the at least one sensing device, the processor is configured for determining a sensing period of the at least one sensing device such that the at least one sensing device does not transmit to-be-sensed information to the electronic device at a designated time.

17. Thee electronic device of claim 11, wherein in case of controlling the sensing period of the at least one of the 1^{st} and 2^{nd} sensing devices, the processor is configured for transmitting to the at least one of the 1^{st} and 2^{nd} sensing devices a command for requesting the at least one of the 1^{st} and 2^{nd} sensing devices to sense a surrounding environment according to the changed sensing period.

18. Thee electronic device of claim 17, wherein the command for requesting the at least one of the 1^{st} and 2^{nd} sensing devices to sense the surrounding environment according to the changed sensing period comprises a sensing period of the at least one of the 1^{st} and 2^{nd} sensing devices and an operation condition of the sensing period.

19. The electronic device of claim 11, wherein in case of controlling the sensing period of the at least one sensing device comprised in the group, the processor is configured for transmitting to the at least one of the 1^{st} and 2^{nd} sensing devices a command for requesting the at least one of the 1^{st} and 2^{nd} sensing devices to perform sensing with a 1^{st} sensing period, and transmitting to the at least one of the 1^{st} and 2^{nd} sensing devices a command for requesting the at least one sensing device to perform sensing with a 2^{nd} sensing period different from the 1^{st} sensing period when a designated time elapses.

20. Thee electronic device of claim 11, wherein the processor is configured for determining at least one of a sensing attribute and a sensing time slot, and in case of identifying the 1^{st} information set and the 2^{nd} information set, the processor is configured for identifying an information set comprising a sensing value corresponding at least one of the determined sensing attribute and sensing time slot.
